(19) United States
(12) Patent Application Publication
(10) Pub. No.: US 2016/0353921 A1
(43) Pub. Date: Dec. 8, 2016

(54) Machine & System for Obtaining Precise Cooking Times of Irregular Shaped Food Objects

(71) Applicant: Travis James Dodge, Tacoma, WA (US)

(72) Inventor: Travis James Dodge, Tacoma, WA (US)

(73) Assignee: Travis James Dodge, Tacoma, WA (US)

(21) Appl. No.: 14/729,062

(22) Filed: Jun. 3, 2015

(51) Int. Cl. A47J 36/00; G05B 15/02; G06F 17/30

(52) U.S. Cl. CPC A47J 36/00; G06F 17/30595; G06F 17/30312; G05B 15/02

(57) ABSTRACT

A machine and system in the art of precision cooking, which can be a stand-alone appliance, or integrated into a thermally insulated chamber; the machine having means to collect geometric, physical, and thermal values; having access to an electronic database of material composition values, a program which through onboard micro-computing or connection to external computing resources, generates a three-dimensional thermo physical model of the irregular shaped food object to be cooked, relating obtained values as to retrieve essential heat conduction variables to render an accurate cook time. The machine and system, once integrated inside a thermally insulated chamber, or in communication with a thermally insulated chamber through an IoT communication platform can, once cook time is calculated, receive feedback from user through a display—this feedback assists in ensuring accurate precision of cooking time by slightly changing the individual users machine to account for irregular variables in the system.

### FIELD OF INVENTION

The present invention is directed to a machine & system that may or may not be integrated into a thermally insulated chamber; which makes the process of collecting data for irregular shaped food objects physical, geometric, material, and thermal properties much more obtainable than previously possible; once collected the system generates the suggested cooking time to be accurate within seconds of the specific food object. The cooking time is then output (or initiates the thermally insulated chamber to begin) via the machine interface.

### BACKGROUND

There are a number of automated cooking machines available today. However, most of these machines & systems lack the most basic processing techniques for achieving precisely cooked food objects. For example, some are limited only to recipes or a limited selection of food classification data.

There is not currently a machine or system that incorporates the technology of my invention to achieve a like purpose or result in, or to my knowledge, outside of the field of invention.

In the past if one was determined to use such basic food parameters to develop a cooking system such as my invention it would require several steps. These would include, for example, weighing the food object, performing a volume dunking measurement in water, and then obtaining the external surface temperature of the food object. However, the surface temperature would be affected during the volume dunking measurement by the water, which also affects the water content, which affects the thermal properties. Having performed these measurements, it would then be necessary to find the characteristic data on the food object, calculate several thermal values, and measure the different thicknesses of the food object with a caliper. After those steps, it would be necessary to find a way to calculate the surface area. This would involve calculating numerous geometric values, especially for an irregularly shaped food object. Then, because equations are not readily available for irregularly shaped food objects it would take a high degree of mathematical skill to manipulate the actual relationship of the different variables. Thermal, material, physical and geometric values would then have to be converted to proper units to finally derive the cook time with precision.

Without a machine & system, which provides an automated way to achieve such precise cooking, the time and effort involved to obtain the necessary information makes it quite nearly impossible. Which is why one can go to a fancy steakhouse in the heart of a bustling city, order a medium rare steak, and get it rare . . . or completely overdone. Or why, one can order a 6 oz chicken breast from a restaurant chain which makes thousands of 6 oz chicken breasts a day, and get it raw or more commonly—overcooked and dry.

The present disclosure provides new and novel solutions to overcome problems inherent in the prior art. Thus, there is needed a precision cooking machine & system which automatically provides the data and control stated for precisely cooking any type of food object.

### BRIEF SUMMARY OF THE INVENTION

This summary is provided to introduce a selection of concepts in a simplified form, although they are further described below in the Detailed Description; this summary is not intended to identify key features of the claimed subject matter, nor is it intended to be used as an aid in determining the scope of the claimed subject matter. Other features, benefits and advantages of the present invention will become apparent from the disclosure, claims and drawings herein.

In one embodiment, a machine for obtaining precise cooking times of irregular shaped food objects includes an enclosure. The machine also includes a temperature sensor. The machine also includes a load cell for obtaining food objects mass. The machine also includes a line laser and camera for obtaining food objects geometric variables. The machine also includes a turntable and means of turning it; however steppers can also drive this feature on a linear track when integrated into a thermally insulated chamber. The machine also includes an embedded microprocessor and microcontroller, however in one embodiment it is connected and the processing can be done on external computing platforms. The machine also includes a display which allows the user to interact with the machine and accurately identify the food object, its initial and desired state, recommended temperatures, and start the process for obtaining a very accurate recommended cooking time within seconds.

In one embodiment the machine is embodied outside of the thermally insulated chamber; however the system can also be integrated inside either a microwave or conventional oven.

### BRIEF DESCRIPTION OF THE DRAWINGS

While the novel features of the invention are set forth with particularity in the appended claims, the invention, both as to organization and content, will be better understood and appreciated, along with other objects and features thereof, from the following detailed description taken in conjunction with the drawings, in which:

FIG. 1 schematically shows a block diagram of the critical internal components of the machine & system in accordance with the instant disclosure.

FIG. 2 schematically shows a flow diagram of the critical internal components of the system & machine including a communication network.

FIG. 3 schematically shows a flow diagram of the machine & system external and standing alone to a thermally insulated chamber as used in one example disclosed herein.

FIG. 4 schematically shows a flow diagram of another example of the machine & system integrated into a thermally insulated chamber using externally connected sensors.

FIG. 5 schematically shows a perspective view of an example of the machine & system external to a thermally insulated chamber as a standalone countertop appliance.

In the drawings, identical reference numbers identify similar elements or components. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

### DETAILED DESCRIPTION OF THE EXAMPLE EMBODIMENTS

The following disclosure describes a machine & system for obtaining precise cook times of irregular shaped food objects. Several features of the machine & system are in accordance with example embodiments set forth and described in the Figures. It will be appreciated that the machine & system in accordance with other example embodiments can include additional procedures or features different than those shown in the Figures.

Example embodiments are described herein with respect to a machine & system for precision cooking. However, it will be understood that these examples are for the purpose of illustrating the principles, and that the invention is not so limited. Additionally, the machine in accordance with several example embodiments may not include all of the features shown in the Figures.

Unless the context requires otherwise, throughout the specification and claims which follow, the word “comprise” and variations thereof, such as, “comprises” and “comprising” are to be construed in an open, inclusive sense that is as “including, but not limited to.” Reference throughout this specification to “one example” or “an example embodiment,” “one embodiment,” “an embodiment” or various combinations and variations of these terms means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In its more salient aspects, the present disclosure is directed to a machine & system that may be a standalone unit or integrated into a thermally insulated chamber such as a conventional or microwave oven. A scanning mechanism provided herein automatically generates geometric data for both regular and irregularly shaped food objects.

The machine & system also provides mechanisms to collect current state and material, physical, geometric and thermal property data. The system accesses stored material composition data to compute the necessary thermal variables specific to a selected food object.

The result is a machine & system that provides a cooking time for food objects to a high degree of accuracy. The machine and system thereby allows a level of precision to either household or commercial cooking. In one embodiment, the machine provided is intelligent enough to account for inconsistent variables in aggregate. This is done using features including active database management, continual regression and data capture.

Elements of the machine & system will also be able to further develop the precision of thermal variables in relation to a food object's material properties. The machine & system will also allow the ability to add a multiplier into an individual user's machine so as to essentially learn the fault risk of its environment and allow correction to the machines processing unit by integrated sensor or user input through the machines error notification interface. As an example, the system can identify and adjust for a thermally insulated chamber which does not project accurate wattage to the user, whether the appliance is located in areas with abnormal atmosphere pressure, or more commonly, has a weak temperature gauge which allows thermal chamber temperature fluctuation.

It is contemplated that the machine disclosed herein can obtain precise cooking times of both regular and irregular shaped food objects. In certain contemplated embodiments the system disclosed herein can be implemented using a phone and web or cloud based application or some further “smart case” which allows the phone to harness sensors in its proximity. In other contemplated embodiments the machine & system disclosed herein can be implemented using a countertop device with proper scanner, sensors, and connectivity. In other contemplated embodiments the system disclosed herein can be implemented using thermally robust components and shields inside an existing or modified thermally insulated chamber.

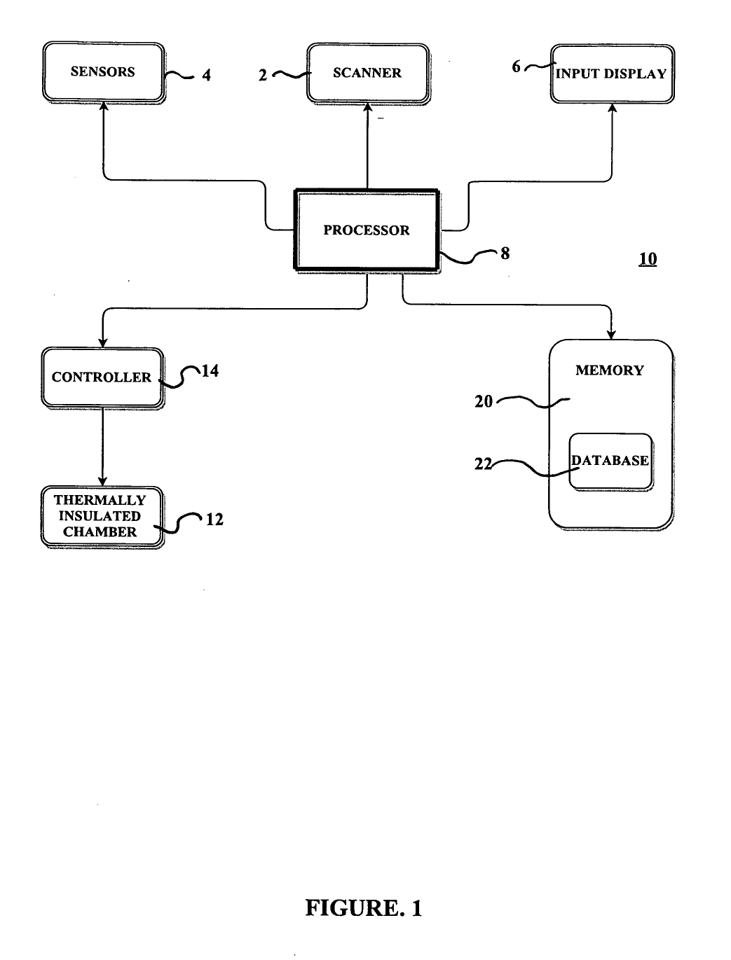

Referring now to FIG. 1, a block diagram of a precision cooking machine & system made in accordance with the instant disclosure is schematically shown. A machine for precisely cooking food objects 10 includes a thermally insulated chamber 12, an input display device 2 for selecting the food category and object type, a scanner 4 for determining volume and other geometric variables, a plurality of sensors 6, a processor 8 for supplying cooking requirements in response to measurements; a controller 14 coupled to the thermally insulated chamber 12, and a memory 20 for supplying control data for the oven and for storing the relational database 22.

In one example the plurality of sensors 6 may include any one or more of a temperature sensor for measuring an initial food temperature, and a load cell for determining mass of the food object. In another example the machine may include a user rating input; and an adjustment algorithm responsive to the user rating. These are described in more detail below with respect to the other figures.

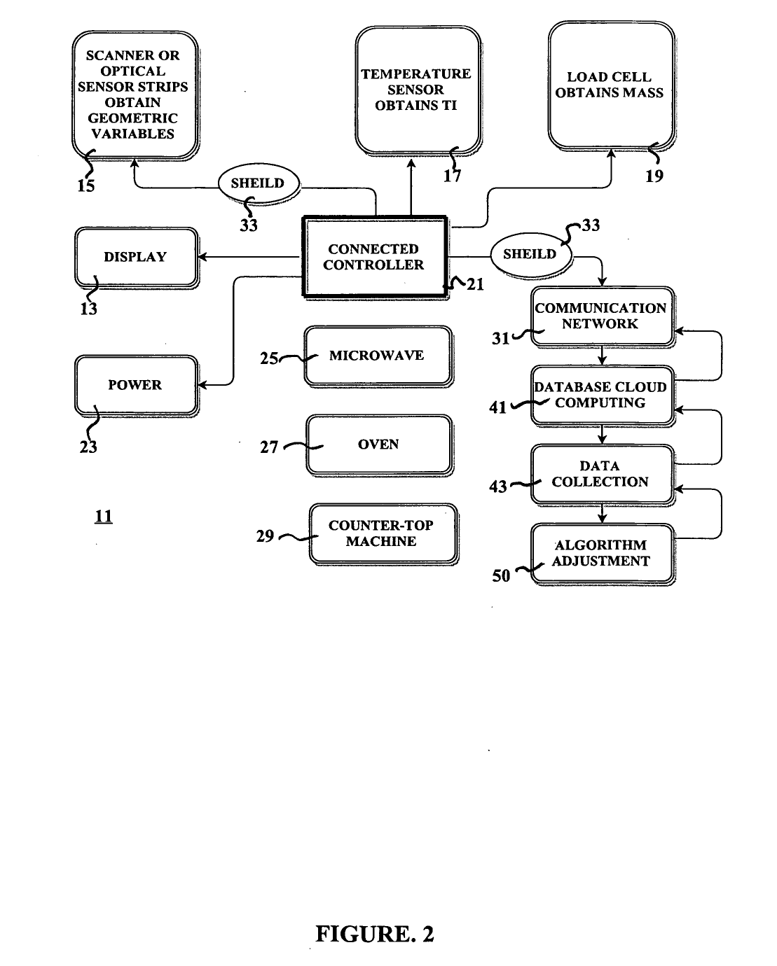

Referring now to FIG. 2, a more detailed block diagram of one example of a precision cooking machine & system including a communication network is schematically shown. The precision cooking machine & system 11 includes a display 13, a temperature sensor 17, a scanner 15, a load cell 19, a connected controller 21, a power source 23, and a microwave 25, or a conventional oven 27, or a standalone countertop machine 29. In some embodiments, the connected controller 21 may be coupled to a communication network 31 through a shield 33. The communication network, in turn, is coupled to a database 41. The database 41 may be coupled to a data collection system 43 which is coupled to transmit and receive information from an algorithm adjustment module 50.

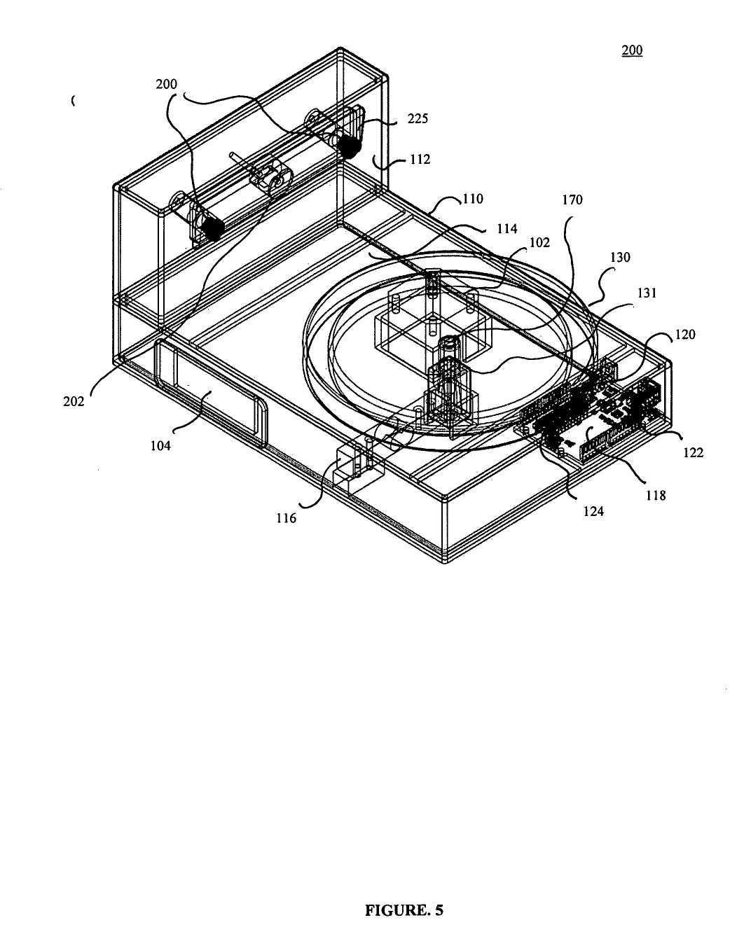

In one example, the temperature sensor 17 is a conventional temperature sensor which obtains the ambient temperature of the food object and transmits information to the connected controller 21. The scanner 15 may comprise an optical sensor or optical strips which are conventionally available to obtain geometric variables characterizing the food object. One example of such a scanner is described in detail below with reference to FIG. 5. The use and design of communication network 31, Internet or cloud computing database 41, and data collection module 43 will be understood by those skilled in the art having the benefit of this disclosure. The adjustment algorithm 50 may be a small multiplier which slightly moves the individual machines algorithm used to fine tune the system or if one specific food object shows a trend it will be adjusted at a macro level to the underlying values.

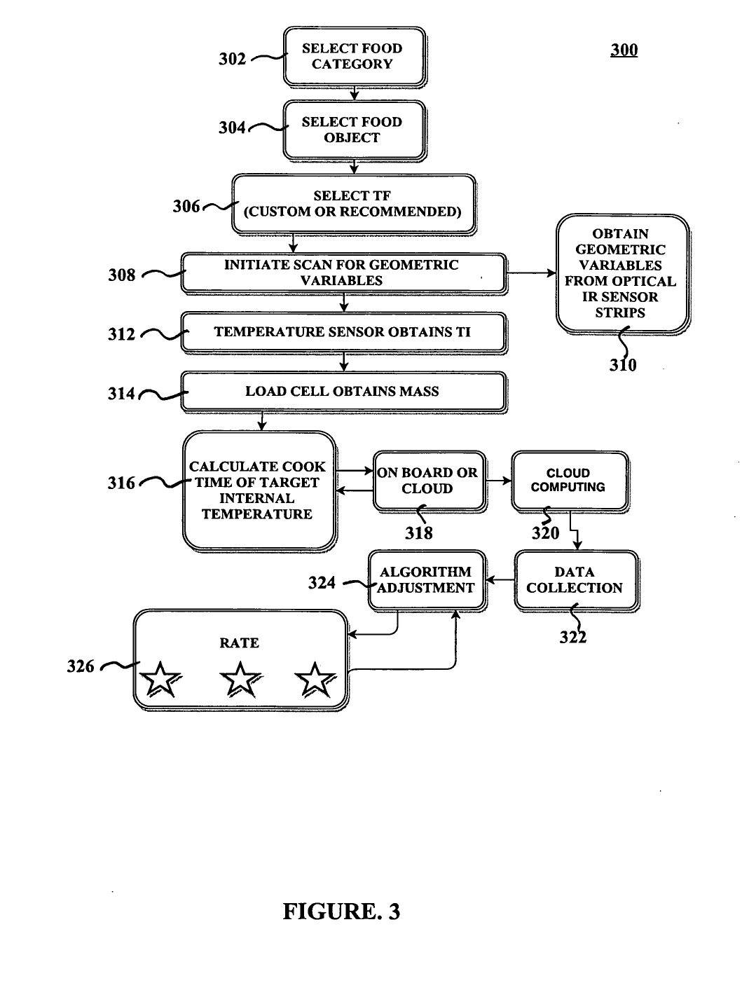

Referring now to FIG. 3, a flow diagram of a precision cooking machine and system, as used in one example is disclosed herein. One example of a precision cooking machine begins with selecting a food category 302, as by a user inputting a food category into the display input device such as poultry, fish, vegetables, etc. Having selected the food category the food object is then selected. For example, if the food category is poultry, the food object may be chicken breasts. In one example, the display device may include a drop-down menu as is supplied in many software programs. Having selected the food object, a recommended cooked temperature T_{f} may be displayed on the drop-down menu or input directly 306 by the user. Having selected the cooking temperature, a scan is initiated for geometric values 308. Alternatively, geometric variables may be obtained from infrared sensor strips 310 as are known in the art.

A temperature sensor obtains the initial temperature Tᵢ 312. A load cell obtains the mass of the food object 314. Having now determined the initial conditions for cooking, a cook time is calculated responsive to the internal temperature Tᵢ. The calculation may be done in an onboard processor as described above, or through a connection to an external processor 318, 320. In either case, data is collected throughout the system 322. Collected data may include data relating to all the components including the sensors, thermally insulated chamber, and user rating 326. The user rating 326 may optionally be included so that a user can provide feedback in the form of a rating which is transmitted to the algorithm adjustment process 324.

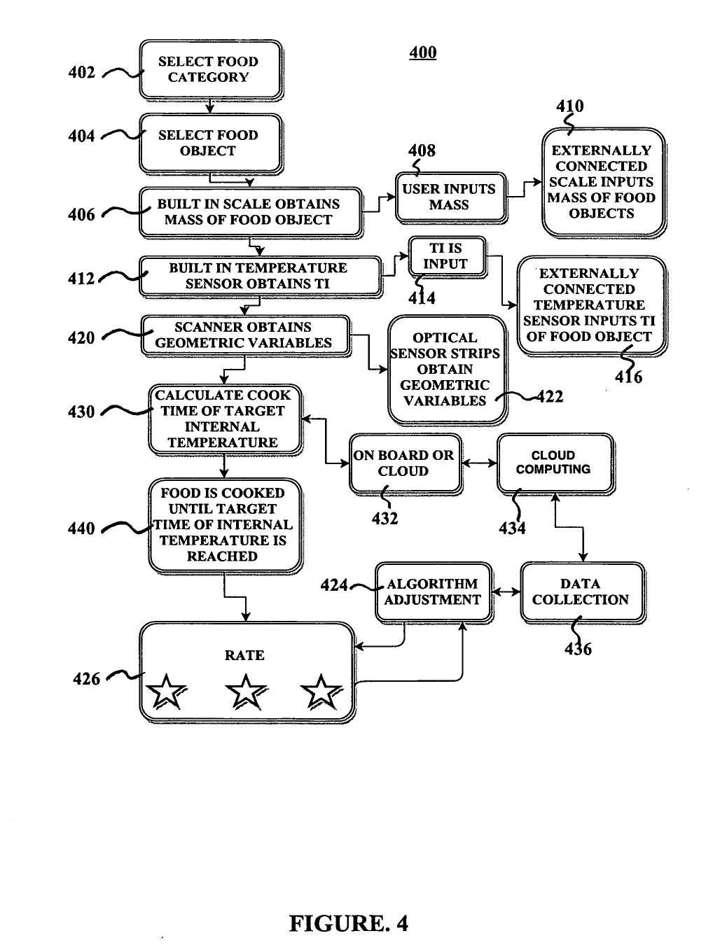

Referring now to FIG. 4, a flow diagram of the machine and system using externally connected sensors is schematically shown. In an alternative example of a precision food cooking system integrated within a thermally insulated chamber 400 using the machine disclosed herein will begin with selecting a food category 402 as described above with reference to FIG. 3. Having selected the food category the food object 404 is then selected as above.

A load cell obtains the mass of the food object 406. Alternatively the user may input the mass of the food object 408 or an externally connected scale may provide the mass of the food object 410. A temperature sensor obtains the initial temperature Tᵢ 406. For this purpose the temperature sensor may integrated into the thermally insulated chamber. Alternatively the initial temperature may be input directly by a user, for example 414 or an externally connected temperature sensor may provide the initial food temperature 416.

Having selected the cooking temperature, a scan is initiated for geometric values 420. Alternatively, geometric variables may be obtained from optical sensor strips, or infrared sensor strips 422 as are known in the art.

Having now determined the initial conditions for cooking, a cook time is calculated 430 responsive to the internal temperature Tᵢ. The calculation may be done in an onboard processor as described above, or through an IoT communication platform to a cloud-based computer 432, 434. In either case, data is collected throughout the system 436. Collected data may include data relating to all the components including the sensors, oven and user rating 426. The user rating 426 may optionally be included so that a user can provide feedback in the form of a rating which is transmitted to the algorithm adjustment process 424.

Referring now to FIG. 5, a perspective view of an example of the standalone countertop machine & system is schematically shown. A sensing platform 100 includes a first housing 110 and the second housing 112. In some embodiments, the first and second housing may be integrated into a single housing. Here, the first housing 110 includes a planar base 114 which is orthogonal to the height of the second housing 112. Integrated into the first housing 110 is a turntable and sleeve 130, rotated by a motor 102. The turntable is located to rotate about a spindle 131 into which a temperature sensor 170 is incorporated. Also contained in the first housing is an electronic circuit 118 which supports a microcontroller 122 and a stepper controller 124. The combination turntable and sleeve 130 is further connected to a load cell 116 fixed, and parallel to the base. Thus, a food item placed on the turntable and sleeve 130 will contact the temperature sensor 170 and impart a load on the load cell 116. The load cell is coupled to a transducer 120 which imparts a signal related to mass into the load cell 116. In this way the initial temperature can be determined by the temperature sensor 170 and the mass determined by the load cell 116.

The integrated scanner 225 includes a plurality of laser diodes 200 and a sensing device, such as a camera 202. Several suitable types of laser diodes are commercially available as are cameras. In operation, the laser diodes are positioned to illuminate a food object placed on the turntable and sleeve so as to provide image data to the camera. The machine is interfaced by a display 104. In this way, regular and irregular shaped food objects may be imaged into a point cloud and the geometric variables can be calculated from the three-dimensional matrix using conventional software techniques.

In one example, the data and relationships amongst the values may be contained in memory on a relational database or spread sheet. In one example, the spreadsheet may include values and relationships such as:
Thermo physical properties,
Thermo physical model,
Calculations of thermal heat transfer coefficients,
Computations of characteristic dimension,
Computations of biot #,
Computations lag factors,
Calculations for cook time, and cook time value,
Regression algorithms for time/temp—heat transfer coefficient relationship using inverse numerical series.

Having described the components of the machine & system it is now considered beneficial to the understanding of the invention to describe its operation and use. In one example, the system flows starting with a User selecting a food category from a list such as a drop down menu; this action categorically keeps the interface on the display uncluttered. Next, a user selects the specific food object from a list. Once selected several properties of the food object can be determined as by reference to the relational database. The user then initiates the machine to start, and the sensor obtains the external temperatures; this action is necessary to obtain for thermal computations. The scale obtains mass, which is needed to obtain accurate material specific values, as well as depict an accurate thermo property model of the food object (ie. density, water content, etc.) The scanner then begins, initiating the motor to spin the turntable, initiating the camera and laser diodes. This operation begins the replication of the irregularly shaped food object in order to obtain accurate geometric values for the food object ie. volume, surface area, min/max thickness, etc. Cook time is then found and displayed using the connected interface. Finally, cook time is rated by user and the rating information is provided to the regression module.

The invention has been described herein in considerable detail in order to comply with the Patent Statutes and to provide those skilled in the art with the information needed to apply the novel principles of the present invention, and to construct and use such exemplary and specialized components as are required. However, it is to be understood that the invention may be carried out by specifically different equipment, and devices, and that various modifications, both as to the equipment details and operating procedures, may be accomplished without departing from the true spirit and scope of the present invention.

What is claimed is:

1. A machine & system for obtaining precise cook times of food objects comprising:
an input device for selecting the food object and type;
a scanner for determining volume and other geometric variables;
a temperature sensor for measuring an initial food temperature;
a load cell for determining mass of the food object;
a processor for supplying cooking requirements in response to measurements;
a processor for supplying cooking requirements in response to food material;
a relational database;
a controller;
a memory for supplying control data and for storing the relational database;
a user rating input; and
an adjustment algorithm responsive to the user rating.

2. The machine & system of claim 1 where the relational database includes algorithms incorporating geometric values.

3. The machine & system of claim 1 where the relational database comprises:
metrics for providing precise cooking conditions responsive to food object thermal properties, material makeup, numerical constants, shape factors, and a food objects initial temperature;
where the processor is coupled to the relational database and selects cooking parameters from the relational database responsive to the thermal data, the scanning data and the food object classification to the relational database, then calculates cooking control data responsive to the selected cooking parameters and transmits the cooking control parameters to the controller.

4. The machine & system of claim 4 where the cooking control parameters include a cooking period and a cooking temperature.

5. The machine & system of claim 1 where the load cell comprises a scale for weight measurement.

6. A machine & system for cooking a food object comprising:
operating a temperature sensor to provide an initial temperature for the food object;
operating optical scanner components to scan the selected food object and collect geometric data for the specific food object;
operating a load cell to generate a mass value for the food object;
inputting a preselected thermally insulated chamber temperature;
operating a processor to determine volume values and geometric values proportional to the imaging data;
accessing a relational database and selecting cooking data and food type formulas that characterize the selected food object, where the selected cooking data and food type formulas are selected responsive to the temperature, mass, and geometric values;
transmitting the selected cooking data and food type formulas to the processor;
operating the processor to calculate cooking control data responsive to the selected cooking data and generating cooking control signals responsive thereto; and
transmitting the cooking control signals to the thermally insulated chamber controller.

7. The machine of claim 7 wherein the relational database comprises data for a plurality of food objects defining properties including:
Thermo physical properties;
Thermo physical model;
Calculate Thermal Heat Transfer Coefficient;
Compute Characteristic Dimension;
Compute Biot #;
Compute lag factors;
Calculate cook time; and
Cook values.
